(19) United States
(12) Patent Application Publication
(10) Pub. No.: US 2009/0180284 A1
(43) Pub. Date: Jul. 16, 2009

(54) Light emitting diode lamp

(76) Inventors: Chung Yiu Lin, Taipei City (TW); Yung Tai Chen, Keelung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/007,398

(22) Filed: Jan. 10, 2008

(51) Int. Cl. F21V 29/00

(52) U.S. Cl. 362/294

(57) ABSTRACT

A light emitting diode (LED) lamp includes a base and a pivotally turnable lamp holder connected to the base. The lamp holder is internally provided with at least one LED and a heat sink. The heat sink has a plurality of longitudinally spaced rows of upright radiating fins provided thereon with the radiating fins in each row transversely spaced from one another and a long slot having a predetermined length formed between any two adjacent radiating fins in each row. The heat sink is also provided with at least one round mounting hole for the LED to mount therein. The heat sink and the radiating fins and long slots provided thereon help in dissipating heat produced by the LED during the operation thereof to thereby enable prolonged usable life of the LED lamp.

### FIELD OF THE INVENTION

The present invention relates to an LED lamp, and more particularly to an LED lamp that can be easily assembled for use and provides good heat dissipation effect to ensure good quality and long usable life thereof.

### BACKGROUND OF THE INVENTION

A conventional desk lamp usually uses a bulb or a fluorescent tube as a light source for illumination. However, with the advancement in technical fields, the highly bright light emitting diode (LED) has been successfully developed to gradually replace the conventional bulb and fluorescent tube to provide good illuminating effect. While the LED lamp is widely welcome among consumers, it produces a large quantity of heat during the operation thereof, and requires a heat radiating structure to effectively dissipate the produced heat, lest the heat accumulated in the lamp should adversely shorten the usable life of the LED lamp. In most conventional LED lamps, the heat radiating structure causes inconvenience in assembling the LED lamp and does not provide good heat dissipation effect. It is therefore tried by the inventor to develop an improved LED lamp that can be easily assembled and provides good heat dissipation effect.

### SUMMARY OF THE INVENTION

A primary object of the present invention is to provide an LED lamp that can be easily assembled for use and provides good heat dissipation effect to ensure good quality and long usable life thereof.

To achieve the above and other objects, the LED lamp according to the present invention includes a base and a pivotally turnable lamp holder connected to the base. The lamp holder is internally provided with at least one LED and a heat sink. The heat sink has a plurality of longitudinally spaced rows of upright radiating fins provided thereon with the radiating fins in each row transversely spaced from one another and a long slot having a predetermined length formed between any two adjacent radiating fins in each row. The heat sink is also provided with at least one round mounting hole for the LED to mount therein. The heat sink and the radiating fins and long slots provided thereon help in dissipating heat produced by the LED during the operation thereof to thereby enable prolonged usable life of the LED lamp.

In the LED lamp of the present invention, the lamp holder is internally provided with multiple pairs of slide rails, and the heat sink is slidably mounted on one pair of the slide rails.

In the LED lamp of the present invention, the lamp holder further includes a bottom plate slidably mounted on another pair of the slide rails. Both of the lamp holder and the bottom plate have a plurality of spaced through openings formed thereon, and the through openings cooperate with the heat sink to provide optimal heat dissipation for the LED lamp.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of an LED lamp according to a preferred embodiment of the present invention;

FIG. 2 is a fragmentary exploded perspective view of the LED lamp of FIG. 1;

FIG. 3 is a bottom perspective view showing the assembling of an LED to a heat sink for the LED lamp of the present invention;

FIG. 4 is a partially sectioned side view of the LED lamp of FIG. 1; and

FIG. 5 shows the LED lamp of FIG. 1 in use.

### DETAILED DESCRIPTION OF THE PREFERRED EMBODIMENTS

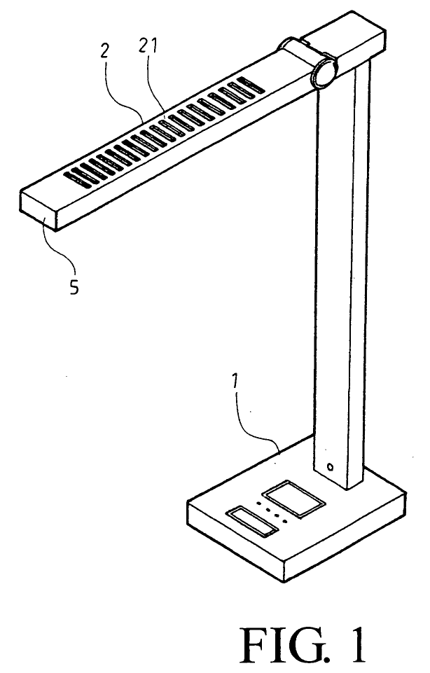

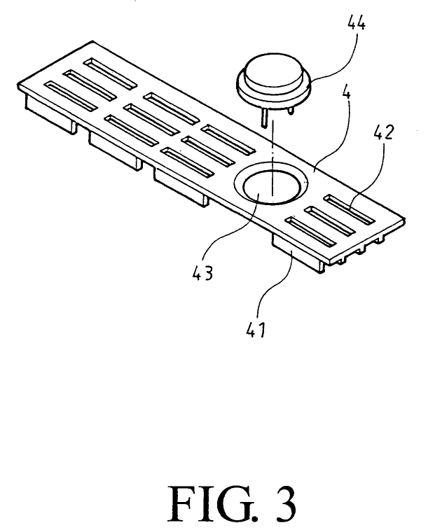

Please refer to FIGS. 1, 2, and 3 at the same time. A light emitting diode lamp according to a preferred embodiment of the present invention includes a base 1, and a pivotally turnable lamp holder 2 connected to the base 1. In the lamp holder 2, one or more light emitting diodes (LED) 44 are arranged to provide the function of illumination. In the illustrated embodiment, only one LED 44 is shown. The lamp holder 2 includes a detachable bottom plate 3. A plurality of through spaced openings 21, 31 are provided on the lamp holder 2 and the bottom plate 3, respectively.

The lamp holder 2 is internally provided with multiple pairs of slide rails 22. A heat sink 4 in the form of a flat plate is slidably mounted on one pair of the slide rails 22. The heat sink 4 is provided with a plurality of longitudinally spaced rows of upright radiating fins 41. The radiating fins 41 in each row are transversely spaced, and a long slot 42 having a predetermined length is formed between any two adjacent radiating fins 41 in each row. One or more round mounting holes 43 may be separately formed on the heat sink 3 between two adjacent rows of radiating fins 41 for the LED 44 to mount therein. In the illustrated embodiment, only one mounting hole 43 is shown.

After the heat sink 4 is mounted in the lamp holder 2 and the bottom plate 3 is slid onto another pair of slide rails 22 to be held in place on the lamp holder 2, an end cap 5 is fitted to an open free end of the lamp holder 2 to complete the LED lamp of the present invention. Then, the LED 44 may be lighted to provide the function of illumination.

With the above arrangements, the LED lamp of the present invention can be very easily assembled for use. Moreover, the heat sink 4 and the radiating fins 44 and long slots 42 provided thereon help in dissipating the heat produced by the LED 44 during the operation thereof to thereby enable prolonged usable life of the LED lamp.

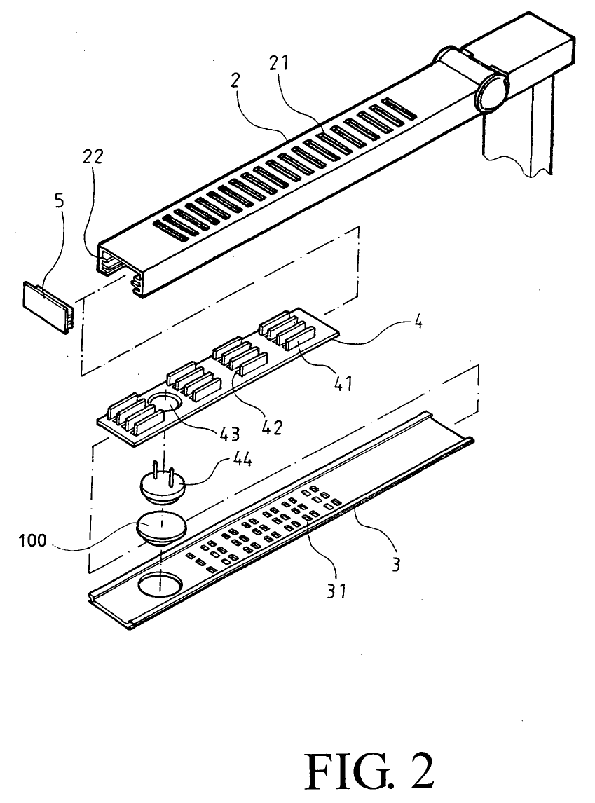

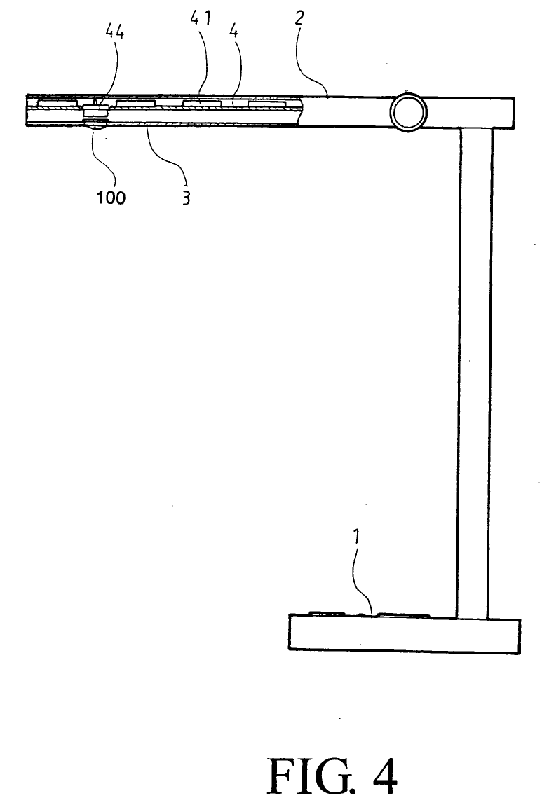

Please refer to FIG. 4 along with FIG. 2. When the LED lamp of the present invention is fully assembled, the heat sink 4 is located in the lamp holder 2 with the light from the LED 44 being projected downward to illuminate the ambient environment. Since the LED 44 is fixedly mounted on the heat sink 4, and the heat sink 4 is located in the lamp holder 2, the heat produced by the LED 44 during the operation thereof may be dissipated via not only the radiating fins 41 and the long slots 42 on the heat sink 4, but also the through openings 21, 31 provided on the lamp holder 2 and the bottom plate 3. Therefore, the LED lamp of the present invention provides enhanced heat dissipation effect to thereby ensure an extended service life thereof.

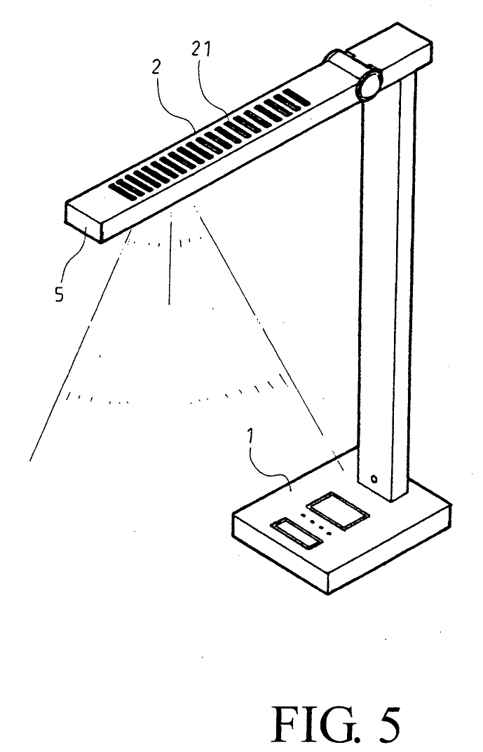

FIG. 5 shows the LED lamp of the present invention in use. As shown, light from the LED 44 in the lamp holder 2 is projected downward for illumination. The lamp holder 2 is pivotally turnable about a pivot joint provided thereon. When the LED lamp is not in use, the lamp holder 2 may be turned at the pivot joint toward the base 1, so that the LED lamp may be conveniently stored.

In brief, the LED lamp of the present invention has a pivotally turnable lamp holder, to which a heat sink may be easily mounted for supporting at least one LED thereon. And, heat produced by the LED during the operation thereof may be efficiently dissipated via the radiating fins 41, the long slots 42, and the through openings 21, 31 to ensure the quality and service life of the LED lamp.

What is claimed is:

1. A light emitting diode (LED) lamp, comprising a base, and a pivotally turnable lamp holder connected to the base; the lamp holder being internally provided with at least one LED to provide the function of illumination; the LED lamp being characterized in that the lamp holder is internally provided with a heat sink, on which a plurality of longitudinally spaced rows of upright radiating fins is provided with the radiating fins in each row transversely spaced from one another and a long slot having a predetermined length formed between any two adjacent radiating fins in each row; and that at least one round mounting hole is formed on the heat sink between two adjacent rows of the radiating fins for the LED to mount therein; and wherein the heat sink and the radiating fins and long slots provided thereon help in dissipating heat produced by the LED during the operation thereof to thereby enable prolonged usable life of the LED lamp.

2. The LED lamp as claimed in claim 1, wherein the lamp holder is internally provided with multiple pairs of slide rails, and the heat sink is slidably mounted on one pair of the slide rails.

3. The LED lamp as claimed in claim 1, wherein the lamp holder further includes a bottom plate; the lamp holder and the bottom plate having a plurality of spaced through openings formed thereon, and the through openings cooperating with the heat sink to provide enhanced heat dissipation effect.
